(19) United States
(12) Patent Application Publication
(10) Pub. No.: US 2025/0374095 A1
(43) Pub. Date: Dec. 4, 2025

(54) COMMUNICATION METHODS AND COMMUNICATION APPARATUSES

(71) Applicant: GUANGDONG OPPO MOBILE TELECOMMUNICATIONS CORP., LTD., Dongguan (CN)

(72) Inventors: Boyuan ZHANG, Dongguan (CN); Zhenshan ZHAO, Dongguan (CN)

(73) Assignee: GUANGDONG OPPO MOBILE TELECOMMUNICATIONS CORP., LTD., Dongguan (CN)

(21) Appl. No.: 19/304,226

(22) Filed: Aug. 19, 2025

Related U.S. Application Data
(63) Continuation of application No. PCT/CN2021/137109, filed on Dec. 10, 2021.

(51) Int. Cl. H04W 24/08; H04W 74/0816; H04W 80/02; H04W 92/18

(52) U.S. Cl. CPC H04W 24/08; H04W 74/0816; H04W 80/02; H04W 92/18

(57) ABSTRACT

Provided are communication methods and communication apparatuses. A method includes: a terminal device sends first information to a network device, the first information being used for indicating consistent Listen Before Talk (LBT) failures on a sidelink; and the terminal device receives second information sent by the network device, the second information being used for indicating an auxiliary resource for the sidelink, and the auxiliary resource being used by the terminal device to perform service transmission on the sidelink.

### CROSS-REFERENCE TO RELATED APPLICATIONS

This application is a continuation of International Application No. PCT/CN2021/137109, filed on Dec. 10, 2021, the disclosure of which is hereby incorporated by reference in its entirety.

### TECHNICAL FIELD

This application relates to the field of communications technologies, and more specifically, to a communication method and a communications apparatus.

### BACKGROUND

As communications technologies develop, listen before talk (LBT) for an unlicensed band is introduced in some communications systems, so that a terminal device can perform communication on the unlicensed bands. However, it is unclear how the terminal device performs communication when an LBT consistent failure occurs.

### SUMMARY

This application provides a communication method and a communications apparatus, so that service continuity can be ensured.

According to a first aspect, a communication method is provided, including: transmitting, by a terminal device, first information to a network device, where the first information is used to indicate a listen before talk LBT consistent failure on a sidelink; and receiving, by the terminal device, second information transmitted by the network device, where the second information is used to indicate an auxiliary resource for the sidelink, and the auxiliary resource is used by the terminal device to perform service transmission on the sidelink.

According to a second aspect, a communication method is provided, including: receiving, by a network device, first information transmitted by a terminal device, where the first information is used to indicate a listen before talk LBT consistent failure on a sidelink; and transmitting, by the network device, second information to the terminal device based on the first information, where the second information is used to indicate an auxiliary resource for the sidelink, and the auxiliary resource is used by the terminal device to perform service transmission on the sidelink.

According to a third aspect, a communications apparatus is provided, including: a transmitting unit, configured to transmit first information to a network device, where the first information is used to indicate a listen before talk LBT consistent failure on a sidelink; and a receiving unit, configured to receive second information transmitted by the network device, where the second information is used to indicate an auxiliary resource for the sidelink, and the auxiliary resource is used by the apparatus to perform service transmission on the sidelink.

According to a fourth aspect, a communications apparatus is provided, including: a receiving unit, configured to receive first information transmitted by a terminal device, where the first information is used to indicate a listen before talk LBT consistent failure on a sidelink; and a transmitting unit, configured to transmit second information to the terminal device based on the first information, where the second information is used to indicate an auxiliary resource for the sidelink, and the auxiliary resource is used by the terminal device to perform service transmission on the sidelink.

According to a fifth aspect, a communications apparatus is provided, including a memory and a processor, where the memory is configured to store a program, and the processor is configured to invoke the program in the memory to perform the method according to the first aspect.

According to a sixth aspect, a communications apparatus is provided, including a memory and a processor, where the memory is configured to store a program, and the processor is configured to invoke the program in the memory to perform the method according to the second aspect.

According to a seventh aspect, a communications apparatus is provided, including a processor, configured to invoke a program from a memory to perform the method according to the first aspect.

According to an eighth aspect, a communications apparatus is provided, including a processor, configured to invoke a program from a memory to perform the method according to the second aspect.

According to a ninth aspect, a chip is provided, including a processor, configured to invoke a program from a memory to cause a device on which the chip is installed to perform the method according to the first aspect.

According to a tenth aspect, a chip is provided, including a processor, configured to invoke a program from a memory to cause a device on which the chip is installed to perform the method according to the second aspect.

According to an eleventh aspect, a computer-readable storage medium is provided, where a program is stored on the computer-readable storage medium, and the program causes a computer to perform the method according to the first aspect.

According to a twelfth aspect, a computer-readable storage medium is provided, where a program is stored on the computer-readable storage medium, and the program causes a computer to perform the method according to the second aspect.

According to a thirteenth aspect, a computer program product is provided, including a program, where the program causes a computer to perform the method according to the first aspect.

According to a fourteenth aspect, a computer program product is provided, including a program, where the program causes a computer to perform the method according to the second aspect.

According to a fifteenth aspect, a computer program is provided. The computer program causes a computer to perform the method according to the first aspect.

According to a sixteenth aspect, a computer program is provided. The computer program causes a computer to perform the method according to the second aspect.

### BRIEF DESCRIPTION OF DRAWINGS

FIG. 1 is an example diagram of a wireless communications system to which embodiments of this application are applied.

FIG. 2 is a schematic flowchart of a communication method according to an embodiment of this application.

FIG. 3 is a schematic diagram of a MAC CE according to an embodiment of this application.

FIG. 4 is a schematic diagram of a structure of a communications apparatus according to an embodiment of this application.

FIG. 5 is a schematic diagram of a structure of a communications apparatus according to another embodiment of this application.

FIG. 6 is a schematic diagram of a structure of an apparatus according to an embodiment of this application.

### DESCRIPTION OF EMBODIMENTS

Technical solutions in this application are described below with reference to the accompanying drawings.

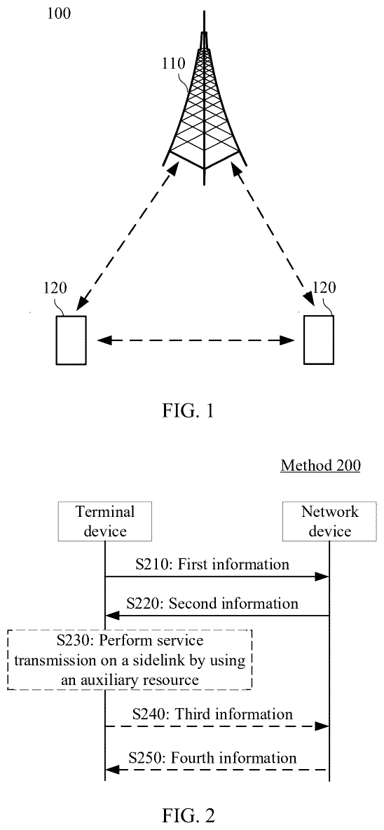

FIG. 1 shows a wireless communications system 100 to which embodiments of this application are applied. The wireless communications system 100 may include a network device 110 and a user equipment (UE) 120. The network device 110 may communicate with the UE 120. The network device 110 may provide communication coverage for a specific geographic area, and may communicate with the UE 120 within the coverage. The UE 120 may access a network (for example, a wireless network) by using the network device 110.

FIG. 1 exemplarily shows one network device and two UEs. Optionally, the wireless communications system 100 may include a plurality of network devices, and another quantity of terminal devices may be included within coverage of each network device, which is not limited in embodiments of this application. Optionally, the wireless communications system 100 may further include another network entity such as a network controller or a mobility management entity, which is not limited in embodiments of this application.

It should be understood that the technical solutions of embodiments of this application may be applied to various communications systems, such as a 5th generation (5G) system or a new radio (NR) system, a long term evolution (LTE) system, an LTE frequency division duplex (FDD) system, and an LTE time division duplex (TDD) system. The technical solutions provided in this application may further be applied to a future communications system, such as a 6th generation mobile communications system or a satellite communications system.

The UE in embodiments of this application may alternatively be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device for communicating with the UE. The network device may alternatively be referred to as an access network device or a radio access network device. For example, the network device may be a base station. The network device in embodiments of this application may be a radio access network (RAN) node (or device) that connects the UE to a wireless network. The base station may broadly cover various names in the following, or may be replaced with the following names: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

In some embodiments, the network device may be stationary or mobile. For example, a helicopter or an unmanned aerial vehicle may be configured to function as a mobile network device, and one or more cells may move depending on a location of the mobile network device. In other examples, a helicopter or an unmanned aerial vehicle may be configured to function as a device that communicates with another network device. In some embodiments, the network device may be a CU or a DU, or the network device may include a CU and a DU, or the network device may further include an AAU.

It should be understood that the network device may be deployed on land, including being indoors or outdoors, handheld, or vehicle-mounted, may be deployed on a water surface, or may be deployed on a plane, a balloon, or a satellite in the air. In embodiments of this application, the network device and a scenario in which the network device is located in embodiments of this application are not limited.

It should further be understood that all or some of functions of the network device and the UE in this application may alternatively be implemented by software functions running on hardware, or by virtualization functions instantiated on a platform (for example, a cloud platform).

Some communications systems support direct communication between terminal devices. For example, the two UEs 120 in FIG. 1 may alternatively perform direct device-to-device communication through a sidelink (SL). The direct communication on the sidelink may include two transmission modes, namely, a mode 1 and a mode 2. Details are as follows.

Mode 1: A transmission resource of a terminal device is allocated by a network device, and the terminal device transmits data on the sidelink based on the resource allocated by the network device. The network device may allocate, to the terminal device, a resource for a single time of transmission, or may allocate, to the terminal device, a resource for semi-static transmission.

Mode 2: The terminal device autonomously selects a resource from a resource pool for data transmission on the sidelink.

As communications technologies develop, listen before talk (LBT) for an unlicensed band is introduced in some communications systems, that is, before the terminal device performs transmission on a shared frequency spectrum channel (for example, the channel may be shared with another system such as wireless fidelity (WIFI) and Bluetooth), the channel needs to be listened on or sensed first to determine whether the channel is idle, and the terminal device may perform transmission only when the channel is idle.

If determining, after listening on the channel, that the channel is busy (non-idle), the terminal device may consider that an LBT failure occurs on the sidelink. If a quantity of times of LBT failures reaches a preset quantity of times (for example, the quantity of times of LBT failures reaches 10), or if a time durationof occurance of the LBT failures reaches a preset duration (for example, the LBT failure lasts for 10 seconds from the time when the LBT failure occurs for the first time), it may be considered that the LBT consistent failure occurs on the sidelink.

At present, it is unclear how the terminal device performs communication when the LBT consistent failure occurs, and a service interruption may occur because the terminal device cannot perform communication.

To resolve one or more of the foregoing technical problems, this application proposes a communication method and a communications apparatus. The following exemplarily describes embodiments of this application in detail with reference to FIG. 2.

FIG. 2 is a schematic flowchart of a communication method according to an embodiment of this application. It should be understood that FIG. 2 shows steps or operations of the communication method. However, these steps or operations are merely examples; and other operations or variations of the operations in FIG. 2 may further be performed in embodiments of this application. Alternatively, not all these steps need to be performed; or these steps may be performed in another sequence. The method 200 shown in FIG. 2 may include steps S210 and S220, which are specifically as follows.

S210: A terminal device transmits first information to a network device.

The first information may be used to indicate a LBT consistent failure on a sidelink.

The first information may further be used to indicate a channel on which the LBT consistent failure occurs, a service on which the LBT consistent failure occurs, a resource on which the LBT consistent failure occurs, and/or the like. Optionally, the first information may further include a first parameter corresponding to the LBT consistent failure, and the first parameter may indicate a channel on which the LBT consistent failure occurs, a service on which the LBT consistent failure occurs, a resource on which the LBT consistent failure occurs, and/or the like.

For example, the first parameter may include at least one of the following: a resource pool identifier, a target address identifier, a target address index, a bandwidth part (BWP) identifier, a carrier identifier, a quality of service (QOS) flow identifier, a default priority, or a logical channel (LCH) priority.

The resource pool identifier in the first parameter may indicate a resource pool in which the LBT consistent failure occurs. The target address identifier and the target address index may indicate a target address to which transmission cannot be performed due to occurrence of the LBT consistent failure, that is, the terminal device performs LBT to transmit data to the target address. The BWP identifier may indicate a BWP on which the LBT consistent failure occurs. The carrier identifier may indicate a carrier on which the LBT consistent failure occurs. The QoS flow identifier may indicate a QoS flow on which the LBT consistent failure occurs. The default priority may indicate a priority at which the LBT consistent failure occurs. The LCH priority may indicate a logical channel on which the LBT consistent failure occurs.

The LBT consistent failure may include a plurality of times of LBT failures. For example, the LBT consistent failure may include n times of LBT failures, where n is a positive integer.

Among the plurality of times of LBT failures, a channel on which the LBT failure occurs, a service on which the LBT failure occurs, and a resource on which the LBT failure occurs may be different from one time to another.

Further, the first information may further include n groups of information, the n groups of information respectively indicate second parameters corresponding to n times of LBT failures, and the second parameters may each indicate a channel on which the LBT failure occurs, a service on which the LBT failure occurs, a resource on which the LBT failure occurs, and/or the like.

For example, the second parameter includes at least one of the following: a resource pool identifier, a target address identifier, a target address index, a bandwidth part BWP identifier, a carrier identifier, a quality of service QoS flow identifier, a default priority, or a logical channel LCH priority, where n is a positive integer.

The resource pool identifier in the second parameter may indicate a resource pool in which the LBT failure occurs. The target address identifier and the target address index may indicate a target address to which transmission cannot be performed due to occurrence of the LBT failure, that is, the terminal device performs LBT to transmit data to the target address. The BWP identifier may indicate a BWP on which the LBT failure occurs. The carrier identifier may indicate a carrier on which the LBT failure occurs. The QoS flow identifier may indicate a QoS flow on which the LBT failure occurs. The default priority may indicate a priority at which the LBT failure occurs. The LCH priority may indicate a logical channel on which the LBT failure occurs.

Optionally, the terminal device may transmit the first information to the network device before the LBT consistent failure occurs. In this way, the terminal device may directly report the LBT consistent failure on the sidelink to the network device when predicting that the consistent failure may or will occur (without waiting until the LBT consistent failure occurs), so that the network device can configure or indicate an auxiliary resource for the sidelink for the terminal device in advance, thereby avoiding a service interruption and improving service continuity.

For example, if a quantity of times of LBT failures reaching 10 is considered as occurance of the LBT consistent failure, the terminal device may transmit the first information to the network device in advance (report the LBT consistent failure) when the LBT failure occurs 6 times. Alternatively, if the LBT failure lasing for 10 seconds is considered as occurance of the LBT consistent failure, the terminal device may transmit the first information to the network device in advance when the LBT failure lasts for 6 seconds.

Optionally, the first information may further include at least one of the following: a time when an LBT failure occurs for the first time, a quantity of times of consecutive LBT failures, and prediction information. The prediction information may be used to predict whether the LBT consistent failure occurs. In this way, the network device may predict, based on the information, that the consistent failure may or will occur on the terminal device, and configure or indicate the auxiliary resource for the terminal device in advance (without waiting until the LBT consistent failure occurs), thereby avoiding a service interruption and improving service continuity.

Optionally, in a case in which the time duration of occurance of the LBT failures meets a preset duration or the quantity of times of the consecutive LBT failures meets a preset quantity of times, the prediction information may be used to predict whether the LBT consistent failure occurs.

For example, if a quantity of times of LBT failures reaching 10 is considered as occurance of the LBT consistent failure, the terminal device may set, when the LBT failure occurs 8 times, the prediction information to that the LBT consistent failure will occur. Alternatively, if the LBT failure lasting for 10 seconds, is considered as occurance of the LBT consistent failure, the terminal device may set, when the LBT failure lasts for 8 seconds, the prediction information to that the LBT consistent failure will occur.

The terminal device may transmit the first information to the network device by using a media access control control element (MAC CE) or a radio resource control (RRC) message.

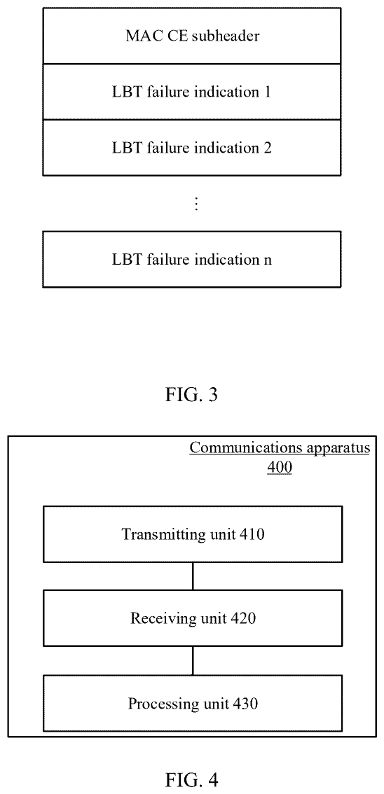

Optionally, when the terminal device transmits the first information to the network device by using the MAC CE, the first information may include n groups of information, and the n groups of information respectively indicate second parameters corresponding to n times of LBT failures. For example, as shown in FIG. 3, the MAC CE may include a MAC CE subheader and n groups of LBT failure indications, namely, an LBT failure indication 1, an LBT failure indication 2, . . . , and an LBT failure indication n. The n groups of LBT failure indications may respectively indicate the second parameters corresponding to n times of LBT failures.

S220: The network device transmits second information to the terminal device.

Optionally, the network device may transmit the second information to the terminal device based on the first information. Optionally, after receiving the first information, the network device determines, based on the first information, an auxiliary resource configured or indicated for the terminal device, and transmits the second information (indicating the auxiliary resource) to the terminal device.

The second information may be used to indicate the auxiliary resource for the sidelink, and the auxiliary resource may be used by the terminal device to perform service transmission on the sidelink. For example, the terminal device may perform service transmission on a licensed frequency spectrum of the sidelink by using the auxiliary resource.

The auxiliary resource may be a dynamic resource, a semi-static resource, or a resource pool.

Optionally, the auxiliary resource may be a dynamic resource scheduled by the network device by using downlink control information (DCI).

Optionally, the auxiliary resource may alternatively be a configured grant (CG) resource. The configured grant resource may be configured by the network device through RRC signaling. The configured grant resource may be associated with the first parameter corresponding to the LBT consistent failure or the second parameter corresponding to an LBT failure. For example, when the LBT consistent failure occurs on a resource (for example, a resource associated with a target address ID) corresponding to the first parameter, the configured grant resource is used. Alternatively, when the LBT failure occurs on a resource (for example, a resource pool or a BWP) corresponding to the second parameter, the configured grant resource is used.

Optionally, the configured grant resource may be of a configured grant resource type 1 or a configured grant resource type 2.

Optionally, the auxiliary resource may be a resource pool. The resource pool may be associated with the first parameter corresponding to the LBT consistent failure or the second parameter corresponding to an LBT failure. For example, when the LBT consistent failure occurs on a resource (for example, a resource associated with a target address ID) corresponding to the first parameter, the resource pool is used. Alternatively, when the LBT failure occurs on a resource (for example, a resource pool or a BWP) corresponding to the second parameter, the resource pool is used.

Optionally, the resource pool may be valid within a preset time period. For example, the network device may configure a timer for the resource pool, and the terminal device may use a resource in the resource pool before the timer expires. Alternatively, the terminal device may receive the second information to start the timer, and use a resource in the resource pool before the timer expires. In this case, the timer may be preset.

The method 200 may further include step S230. Details are as follows.

S230: The terminal device performs service transmission on the sidelink by using the auxiliary resource.

In a case in which the auxiliary resource is a resource pool, the terminal device may perform service transmission on the sidelink by using a resource in the resource pool based on scheduling of the network device. For example, the network device may schedule the resource in the resource pool for the terminal device by using DCI, so that the terminal device performs service transmission on the sidelink when the LBT consistent failure occurs.

In a case in which the auxiliary resource is a resource pool, the terminal device may perform service transmission on the sidelink by autonomously selecting a resource in the resource pool. For example, the terminal device performs service transmission on the sidelink by selecting the resource in the resource pool through full sensing, partial sensing, or random selection.

The method 200 may further include step S240. Details are as follows.

S240: The terminal device transmits third information to the network device.

The third information may be used to indicate recovery from the LBT consistent failure on the sidelink. For example, when determining the recovery from the LBT consistent failure on the sidelink, the terminal device may transmit the third information to the network device, to inform the network device of the recovery from the LBT consistent failure on the sidelink.

The terminal device may transmit the third information to the network device by using a MAC CE or an RRC message.

The third information may further indicate a channel on which the LBT consistent failure recovers, a service on which the LBT consistent failure recovers, a resource on which the LBT consistent failure recovers, and/or the like. For example, the third information may further include a first parameter corresponding to the LBT consistent failure or a second parameter corresponding to an LBT failure.

The method 200 may further include step S250. Details are as follows.

S250: The terminal device receives fourth information transmitted by the network device.

The fourth information may be used to instruct the terminal device to stop using the auxiliary resource. For example, after learning the recovery from the LBT consistent failure, the network device may instruct the terminal device to stop using the auxiliary resource to perfom the service transmission on the sidelink.

In embodiments of this application, the terminal device reports the LBT consistent failure on the sidelink to the network device, and performs service transmission by using the auxiliary resource based on an indication of the network device, so that the terminal device can continue performing service transmission on the sidelink when the LBT consistent failure occurs, thereby ensuring service continuity.

The method embodiments of this application are described above in detail with reference to FIG. 1 to FIG. 3. Apparatus embodiments of this application are described below in detail with reference to FIG. 4 to FIG. 6. It should be understood that the description of the method embodiments corresponds to the description of the apparatus embodiments, and therefore, for a part that is not described in detail, reference may be made to the foregoing method embodiments.

FIG. 4 is a schematic diagram of a structure of a communications apparatus according to an embodiment of this application. As shown in FIG. 4, the apparatus 400 includes a transmitting unit 410 and a receiving unit 420. Details are as follows.

The transmitting unit 410 is configured to transmit first information to a network device. The first information is used to indicate a listen before talk LBT consistent failure on a sidelink.

The receiving unit 420 is configured to receive second information transmitted by the network device. The second information is used to indicate an auxiliary resource for the sidelink, and the auxiliary resource is used by the apparatus to perform service transmission on the sidelink.

Optionally, the first information further includes a first parameter corresponding to the LBT consistent failure, and the first parameter includes at least one of the following: a resource pool identifier, a target address identifier, a target address index, a bandwidth part BWP identifier, a carrier identifier, a quality of service QoS flow identifier, a default priority, or a logical channel LCH priority.

Optionally, the first information further includes n groups of information, the n groups of information respectively indicate second parameters corresponding to n times of LBT failures, and the second parameters each include at least one of the following: a resource pool identifier, a target address identifier, a target address index, a bandwidth part BWP identifier, a carrier identifier, a quality of service QoS flow identifier, a default priority, or a logical channel LCH priority, where n is a positive integer.

Optionally, the transmitting unit 410 is specifically configured to transmit the first information to the network device by using a media access control control element MAC CE or a radio resource control RRC message.

Optionally, the transmitting unit 410 is specifically configured to transmit the first information to the network device before the LBT consistent failure occurs.

Optionally, the first information further includes at least one of the following: a time when an LBT failure occurs for the first time, a quantity of times of consecutive LBT failures, and prediction information. The prediction information is used to predict whether the LBT consistent failure occurs.

Optionally, in a case in which a time duration of occurance of the LBT failures meets a preset duration or the quantity of times the consecutive LBT failures meets a preset quantity of times, the prediction information is used to predict whether the LBT consistent failure occurs.

Optionally, the auxiliary resource is a dynamic resource, a semi-static resource, or a resource pool.

Optionally, the auxiliary resource is a dynamic resource scheduled by the network device by using downlink control information DCI.

Optionally, the auxiliary resource is a configured grant resource, and the configured grant resource is associated with a first parameter corresponding to the LBT consistent failure or a second parameter corresponding to an LBT failure.

Optionally, the configured grant resource is of a configured grant resource type 1 or a configured grant resource type 2.

Optionally, the auxiliary resource is a resource pool, and the resource pool is associated with a first parameter corresponding to the LBT consistent failure or a second parameter corresponding to an LBT failure.

Optionally, the apparatus 400 further includes a processing unit 430, configured to perform the service transmission on the sidelink by using the auxiliary resource.

Optionally, in a case in which the auxiliary resource is a resource pool, the processing unit 430 is specifically configured to perform the service transmission on the sidelink by using a resource in the resource pool based on scheduling of the network device.

Optionally, in a case in which the auxiliary resource is a resource pool, the processing unit 430 is specifically configured to perform the service transmission on the sidelink by autonomously selecting a resource in the resource pool.

Optionally, the processing unit 430 is specifically configured to perform the service transmission on the sidelink by selecting the resource in the resource pool through full sensing, partial sensing, or random selection.

Optionally, the resource pool is valid within a preset time period.

Optionally, the transmitting unit 410 is further configured to transmit third information to the network device, where the third information is used to indicate recovery from the LBT consistent failure on the sidelink.

Optionally, the third information further includes a first parameter corresponding to the LBT consistent failure or a second parameter corresponding to an LBT failure.

Optionally, the transmitting unit 410 is specifically configured to transmit the third information to the network device by using a MAC CE or an RRC message.

Optionally, the receiving unit 420 is further configured to receive fourth information transmitted by the network device. The fourth information is used to instruct the apparatus to stop using the auxiliary resource.

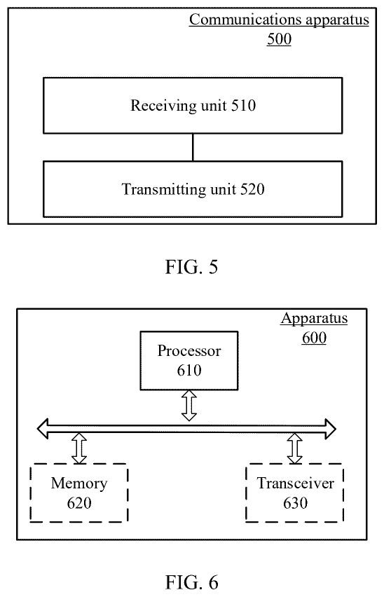

FIG. 5 is a schematic diagram of a structure of a communications apparatus according to an embodiment of this application. The communications apparatus 500 in FIG. 5 includes a receiving unit 510 and a transmitting unit 520. Details are as follows.

The receiving unit 510 is configured to receive first information transmitted by a terminal device. The first information is used to indicate a listen before talk LBT consistent failure on a sidelink.

The transmitting unit 520 is configured to transmit second information to the terminal device based on the first information. The second information is used to indicate an auxiliary resource for the sidelink, and the auxiliary resource is used by the terminal device to perform service transmission on the sidelink.

Optionally, the first information further includes a first parameter corresponding to the LBT consistent failure, and the first parameter includes at least one of the following: a resource pool identifier, a target address identifier, a target address index, a bandwidth part BWP identifier, a carrier identifier, a quality of service QoS flow identifier, a default priority, or a logical channel LCH priority.

Optionally, the first information further includes n groups of information, the n groups of information respectively indicate second parameters corresponding to n times of LBT failures, and the second parameters each include at least one of the following: a resource pool identifier, a target address identifier, a target address index, a bandwidth part BWP identifier, a carrier identifier, a quality of service QoS flow identifier, a default priority, or a logical channel LCH priority, where n is a positive integer.

Optionally, the receiving unit 510 is specifically configured to receive the first information transmitted by the terminal device by using a media access control control element MAC CE or a radio resource control RRC message.

Optionally, the first information further includes at least one of the following: a time when an LBT failure occurs for the first time, a quantity of times of consecutive LBT failures, and prediction information, where the prediction information is used to predict whether the LBT consistent failure occurs.

Optionally, in a case in which a time duration of occurance of the LBT failures meets a preset duration or the quantity of times of the consecutive LBT failures meets a preset quantity of times, the prediction information is used to predict whether the LBT consistent failure occurs.

Optionally, the auxiliary resource is a dynamic resource, a semi-static resource, or a resource pool.

Optionally, the auxiliary resource is a dynamic resource scheduled by the apparatus by using downlink control information DCI.

Optionally, the auxiliary resource is a configured grant resource, and the configured grant resource is associated with a first parameter corresponding to the LBT consistent failure or a second parameter corresponding to an LBT failure.

Optionally, the configured grant resource is of a configured grant resource type 1 or a configured grant resource type 2.

Optionally, the auxiliary resource is a resource pool, and the resource pool is associated with a first parameter corresponding to the LBT consistent failure or a second parameter corresponding to an LBT failure.

Optionally, the resource pool is valid within a preset time period.

Optionally, the receiving unit 510 is further configured to receive third information transmitted by the terminal device. The third information is used to indicate recovery from the LBT consistent failure on the sidelink.

Optionally, the third information further includes a first parameter corresponding to the LBT consistent failure or a second parameter corresponding to an LBT failure.

Optionally, the receiving unit 510 is specifically configured to receive the third information transmitted by the terminal device by using a MAC CE or an RRC message.

Optionally, the transmitting unit 520 is further configured to transmit fourth information to the terminal device. The fourth information is used to instruct the terminal device to stop using the auxiliary resource.

FIG. 6 is a schematic diagram of a structure of an apparatus according to an embodiment of this application. Dashed lines in FIG. 6 indicate that a unit or module is optional. The apparatus 600 may be configured to implement the method described in the foregoing method embodiments. The apparatus 600 may be a chip or a communications apparatus.

The apparatus 600 may include one or more processors 610. The processor 610 may support the apparatus 600 in implementing the method described in the foregoing method embodiments. The processor 610 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 600 may further include one or more memories 620. The memory 620 stores a program, and the program may be executed by the processor 610, to cause the processor 610 to perform the method described in the foregoing method embodiments. The memory 620 may be separated from or integrated into the processor 610.

The apparatus 600 may further include a transceiver 630. The processor 610 may communicate with another device or chip by using the transceiver 630. For example, the processor 610 may transmit data to and receive data from another device or chip by using the transceiver 630.

An embodiment of this application further provides a computer-readable storage medium for storing a program. The computer-readable storage medium may be applied to the communications apparatus provided in embodiments of this application, and the program causes a computer to perform the method performed by the communications apparatus in various embodiments of this application.

An embodiment of this application further provides a computer program product. The computer program product includes a program. The computer program product may be applied to the communications apparatus provided in embodiments of this application, and the program causes a computer to perform the method performed by the communications apparatus in various embodiments of this application.

An embodiment of this application further provides a computer program. The computer program may be applied to the communications apparatus provided in embodiments of this application, and the computer program causes a computer to perform the method performed by the communications apparatus in various embodiments of this application.

It should be understood that, in embodiments of this application, “B that is corresponding to A” means that B is associated with A, and B may be determined based on A. However, it should further be understood that, determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in various embodiments of this application, sequence numbers of the foregoing processes do not mean execution sequences. The execution sequences of the processes should be determined based on functions and internal logic of the processes, and should not be construed as any limitation on the implementation processes of the embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
transmitting, by a terminal device, first information to a network device, wherein the first information is used to indicate a listen before talk (LBT) consistent failure on a sidelink; and
receiving, by the terminal device, second information transmitted by the network device, wherein the second information is used to indicate an auxiliary resource for the sidelink, and the auxiliary resource is used by the terminal device to perform service transmission on the sidelink.

2. The method according to claim 1, wherein the transmitting, by the terminal device, the first information to the network device comprises:
transmitting, by the terminal device, the first information to the network device by using a media access control control element (MAC CE).

3. The method according to claim 1, wherein the auxiliary resource is a resource pool.

4. The method according to claim 1, wherein the method further comprises:
transmitting, by the terminal device, third information to the network device, wherein the third information is used to indicate recovery from the LBT consistent failure on the sidelink.

5. The method according to claim 4, wherein the transmitting, by the terminal device, the third information to the network device comprises:
transmitting, by the terminal device, the third information to the network device by using a media access control control element (MAC CE).

6. A communication method, comprising:
receiving, by a network device, first information transmitted by a terminal device, wherein the first information is used to indicate a listen before talk (LBT) consistent failure on a sidelink; and
transmitting, by the network device, second information to the terminal device based on the first information, wherein the second information is used to indicate an auxiliary resource for the sidelink, and the auxiliary resource is used by the terminal device to perform service transmission on the sidelink.

7. The method according to claim 6, wherein the receiving, by the network device, the first information transmitted by a terminal device comprises:
receiving, by the network device, the first information transmitted by the terminal device by using a media access control control element (MAC CE).

8. The method according to claim 6, wherein the auxiliary resource is a resource pool.

9. The method according to claim 6, wherein the method further comprises:
receiving, by the network device, third information transmitted by the terminal device, wherein the third information is used to indicate recovery from the LBT consistent failure on the sidelink.

10. The method according to claim 9, wherein the receiving, by the network device, the third information transmitted by the terminal device comprises:
receiving, by the network device, the third information transmitted by the terminal device by using a media access control control element (MAC CE).

11. A terminal device, comprising a processor configured to:
transmit first information to a network device, wherein the first information is used to indicate a listen before talk (LBT) consistent failure on a sidelink; and
receive second information transmitted by the network device, wherein the second information is used to indicate an auxiliary resource for the sidelink, and the auxiliary resource is used by the apparatus to perform service transmission on the sidelink.

12. The terminal device according to claim 11, wherein the processor is specifically configured to transmit the first information to the network device by using a media access control control element (MAC CE).

13. The terminal device according to claim 11, wherein the auxiliary resource is a resource pool.

14. The terminal device according to claim 11, wherein the processor is further configured to transmit third information to the network device, wherein the third information is used to indicate recovery from the LBT consistent failure on the sidelink.

15. The terminal device according to claim 14, wherein the processor is specifically configured to transmit the third information to the network device by using a media access control control element (MAC CE).

16. A network device, comprising a processor configured to perform steps of the method of claim 6.

17. The network device according to claim 16, wherein the processor is specifically configured to receive the first information transmitted by the terminal device by using a media access control control element (MAC CE).

18. The network device according to claim 16, wherein the auxiliary resource is a resource pool.

19. The network device according to claim 16, wherein the processor is further configured to receive third information transmitted by the terminal device, wherein the third information is used to indicate recovery from the LBT consistent failure on the sidelink.

20. The network device according to claim 19, wherein the processor is specifically configured to receive the third information transmitted by the terminal device by using a media access control control element (MAC CE).
